(19) United States
(12) Patent Application Publication
(10) Pub. No.: US 2012/0158496 A1
(43) Pub. Date: Jun. 21, 2012

(54) SYSTEM AND METHOD FOR CLASSIFYING WEBPAGES

(76) Inventors: Amiad SOLOMON, New York, NY (US); Jonathan Schler, Petach Tikva (IL); Itay Ovits, Petach Tikva (IL); Yair Liberzon, Petach Tikvah (IL); Kobi Shemer, Netanya (IL)

(21) Appl. No.: 12/973,541

(22) Filed: Dec. 20, 2010

(51) Int. Cl. G06Q 30/00; G06F 15/173

(52) U.S. Cl. 705/14.49; 709/223

(57) ABSTRACT

A system and method for classifying a uniform resource locator (URL) is provided. A URL may be semantically analyzed to produce an analysis result. An advertisement-related classification parameter may be associated with the URL based on the analysis result. The classification parameter may be used in a real time bidding (RTB) process for advertising in a webpage associated with the URL.

### BACKGROUND OF THE INVENTION

Various systems and methods for advertising over the internet exist today. In modern systems, rather than incorporating advertisements into webpages at the website, advertisements are typically dynamically associated with web pages according to various rules, conditions or circumstances. For example, advertisements may be dynamically placed in webpages provided to a user based on a user profile, a time of day, a campaign or any other criteria, rules or logic.

Real time bidding (RTB) is designed to provide an exchange-like, online, real-time market for advertising in webpages. Generally, webpages may have spots or place holders reserved for advertisements and an auction for placing an advertisement in a webpage (or a spot) may be held, enabling advertisers to place bids for advertising in the webpage or spot. The real-time aspect of RTB is related to the fact that an auction for advertising in the webpage may be held close to, or even when, the page is provided to the user. Accordingly, although RTB enables many desirable features to both advertisers and publishers, it also presents a number of problems.

For example, since the process of selecting an advertisement is performed in real time, it has to be fast in order for the advertisement to be displayed when the webpage is displayed to a user or not long thereafter. Another problem may be related to the information available to a bidder. For example, a bidder may improve his bidding decisions based on any relevant information, e.g., the website from which the webpage is provided and/or content in the webpage may be highly valuable information when determining whether or how to bid for a spot in a webpage.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows high level block diagram of an exemplary system according to embodiments of the present invention;

FIG. 2 shows high level block diagram of an exemplary classifier according to embodiments of the present invention;

FIG. 3 depicts a method in accordance with an embodiment of the invention; and

FIG. 4 shows high level block diagram of an exemplary computing device according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding embodiments of the invention. However, it will be understood by those of ordinary skill in the art that embodiments of the invention may be practiced without these specific details. In other instances, well-known methods, procedures, components, modules, units and/or circuits have not been described in detail so as not to obscure embodiments of the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time.

Embodiments of the invention may enable providing valuable information with relation to advertising over the internet. As described herein, a method may comprise determining parameters related to bidding for displaying advertisements in a real time bidding environment based on data or parameters provided by embodiments of the invention. For example, a decision of whether or not to bid for an advertising spot in a webpage and/or how much to bid for an advertising spot in a webpage may be made based on categorization parameters or other information provided, in real time, by an embodiment of the invention.

In particular, embodiments of the invention may be relevant to real time bidding for advertising spots in webpages. Generally, advertisement exchanges (ad exchanges) enable buyers (e.g., advertisers) to bid for advertisements display in webpages provided by publishers. Embodiments of the invention may be related or relevant to various players in the field of internet advertising, e.g., advertisement agencies (ad agencies), demand side platforms (DSP), supply side platforms (SSP), publishers, advertisers, advertisement networks (ad networks) or other marketers. However, for the sake of clarity and simplicity, the description herein will mostly relate to four entities, of which the first may be a publisher, who may provide webpages to web surfers and who may further be involved in providing advertisements to the web surfers in the provided webpages. The second entity may be an advertiser who may wish to advertise a product, service or other goods in a webpage and the third entity is an exchange that may enable a publisher to offer advertising space (e.g., spots in a webpage) and an advertiser to bid for such offered advertising space. The fourth entity may be a system, device or method according to embodiments of the invention that may enable determining and providing parameters or other information related to a real time bidding as described herein. It will be understood that the four entities discussed herein are selected for the sake of clarity and simplicity and that embodiments of the invention may include or comprise more or less entities.

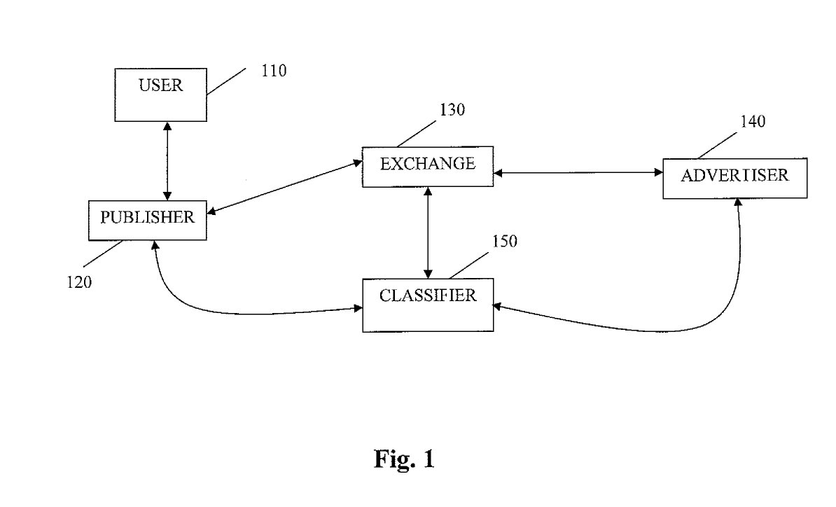

Reference is made to FIG. 1, showing high level block diagram an embodiment of the present invention. As shown, a classifier 150 may be operatively connected to an exchange 130. Exchange 130 may be operatively connected to an advertiser 140 and to a publisher 120. Publisher 120 may be operatively connected to a user 110. It will be understood that advertiser 140, exchange 130, publisher 120 and user 110 may represent any relevant device. For example, user 110 may be a user and an associated laptop or home computer operated by the user who may be surfing the internet and being provided with webpages by or from publisher 120 or it may be a user and an associated wireless device capable of communicating with any relevant component and displaying advertisements to a user, e.g., a smartphone, a wireless personal digital assistance (PDA), a mobile phone etc. Similarly, publisher 120, exchange 130 and/or advertiser 140 may be servers and/or software implementing or facilitating any applicable applications or tasks. It will be understood that although a single user (and associated device) is shown in FIG. 1, in a typical environment, a large number of such users and associated devices may exist. In fact, an exchange 130 may serve dozens of thousands of users who may be provided with advertisements by a large number of advertisers and publishers such as advertiser 140 and publisher 120. Accordingly, it will be understood that any single component shown in FIG. 1 may represent any applicable number of similar components.

Classifier 150 may be or may comprise software, hardware or firmware or any combination thereof. For example, in one particular embodiment, classifier 150 may be a hardware, software or firmware or a combination thereof that may be installed on, or in, exchange 130, e.g., as an addon card or application. In another embodiment classifier 150 may be an appliance that may be operatively connected to exchange 130 over a network, e.g., the internet or over a dedicated communication bus. As shown, classifier 150 may be able to communicate with advertiser 140 and/or with publisher 120. For example, classifier 150 may communicate with advertiser 140, publisher 120 and/or exchange 130 over the internet, over a local network (LAN) over a wireless network or over any suitable infrastructure.

Various components that may typically be included in an environment applicable to embodiments of the invention are omitted in FIG. 1 for the sake of clarity. For example, ad servers and/or related ad networks that may perform the actual providing of advertisements are omitted. Likewise, domain name server (DNS) and/or other entities that may be relevant, e.g., to redirecting ad requests, routing and the like are omitted. Accordingly, in the discussion herein delivery of an advertisement to a user may be performed by publisher 120 even though in many embodiments or environments, other entities may perform the actual delivery of a selected advertisement to a user.

A simplified and general flow to which embodiments of the invention may be related may begin by user 110 requesting a webpage from publisher 120. A requested webpage may include one or more spots or placeholders that may be replaced, filled with, or populated by one or more advertisements. The process of replacing a spot in a webpage by an advertisement may include requesting an advertisement. For example, hypertext markup language (HTML), Java script or other code incorporated in a provided webpage may be executed by a web browser on a computer of user 110 and may cause the web browser to request an advertisement.

A request for an advertisement may include the address of the webpage, or more specifically, a uniform resource locator (URL) associated with the webpage with which a requested advertisement is to be associated. A request for an advertisement may be received by exchange 130, may or may not be associated with a price tag and may be offered for bidding in an auction. Advertisers (e.g., advertiser 140) may place bids for a requested advertisement, and a winner (e.g., the highest bidder) in such auction may have his advertisement placed in the webpage. The process described above may be performed in real time. For example, requesting an advertisement by a web browser as described above may be performed after the webpage has already been delivered to the user and/or even rendered on a display of the user's computer. Accordingly, it may be crucial for the entire process to complete quickly so that the advertisement is displayed while the user is still viewing the page. Accordingly, a typical time constraint for placing a bid for an advertisement as described above may be a few milliseconds

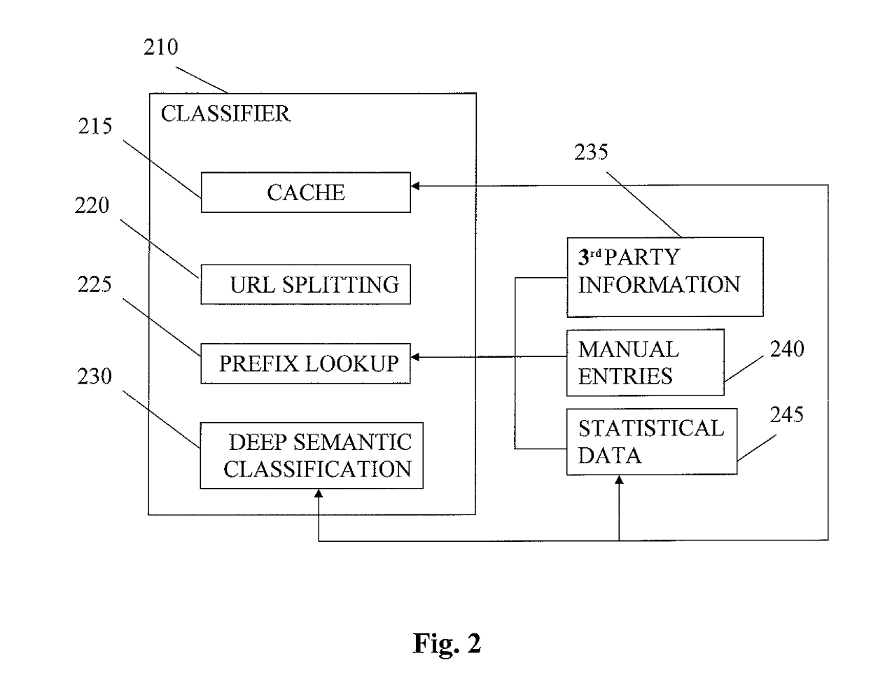

Reference is now made to FIG. 2 that shows a high level schematic block diagram of a classifier and related modules according to embodiments of the invention. As shown, a classifier 210 may include a cache unit 215, a URL splitting unit 220, a prefix lookup unit or module 225 and a deep semantic classification unit 230. As further shown, classifier 210 may include or be operatively connected to a third (3^{rd}) party arty information unit, module and/or repository 235, a manual entry module or repository 240 and a statistical data unit 245. In an exemplary embodiment or implementation, a request for advertisement may be processed by classifier 210 from top to bottom, e.g., starting at the top with cache 215 and possibly (e.g., if no cache hit in cache 215 is made) continuing to URL splitting 220, then possibly prefix lookup 225 and, e.g., if none of the above yield an acceptable result, deep semantic classification 230. As described herein, other sequences of processing a URL by classifier 210 are possible.

In some embodiments, results produced by two or more units of classifier 210 may be combined or otherwise commonly used in order to produce output. For example, results produced by cache 215, URL splitting 220 unit, prefix lookup 225 unit, deep semantic classification 230 unit and/or any one of 3^{rd} party information unit 235, manual entry module 240 and statistical data unit 245. For example, results produced by URL splitting 220 unit, prefix lookup 225 unit may be examined and a result that may be a combination of such results may be produced and provided to a client as described herein. For example, URL splitting 220 unit may associate a URL with a first classification parameter as described herein and prefix lookup 225 unit may associate the same URL with a second classification parameter as described herein. In some embodiments, a client may be provided with both classification parameters, in other embodiments or configurations, one of the classification parameters may be selected (based on any suitable algorithm, method or process) and provided to a client. A classification parameter may be a class, category, group or any other parameter that may classify or categorize a URL as further described herein. Accordingly, associating a URL with a classification parameter may be referred to herein as classifying a URL, associating a URL with a class, categorizing a URL etc. It will be understood that any reference to classifying or categorizing a URL made herein may be or may comprise associating a URL with one or more classification parameters.

In some embodiments, faster components of classifier 210 may produce less accurate results and slower units, or units that may take longer to process a request and produce a classification may produce more accurate results. For example, cache 215 may be very fast in terms of receiving a URL and returning a classification or classification parameter, however, cache misses may occur, and as a result, no classification (or classification parameter) may be produced by cache 215 for some requests. In addition, entries in cache 215 may be associated with a lower granularity than the granularity that may be achieved by URL splitting unit 220 and/or prefix lookup unit 225.

For example, cache 215 may return the same classification parameter, category or classification for all webpages associated with a give web site while URL splitting unit 220 may associate different pages from the given site with different categories. Similarly, given a request, URL splitting unit 220 may produce a classification faster than prefix lookup 225 unit, however, a classification parameter provided by prefix lookup 225 unit may be more accurate or based on a finer granularity. Accordingly, a request may be processed in sequence starting with the fastest unit or entity of classifier 210 and continuing with slower units until a classification parameter is produced. For example, starting with cache 215, a classification of a URL may be produced very fast since, as known in the art, cache techniques and systems may be very fast. If a classification parameter for a URL is not produced by cache 215, URL splitting unit 220 may be provided with the URL and any other relevant parameters and may be activated. Next, if a classification parameter is produced by URL splitting unit 220 then the classification (or a relevant parameter or index) may be provided to a client and a subsequent request may be processed (e.g., starting again with cache 215). Alternatively, if URL splitting unit 220 fails to produce a classification parameter then prefix lookup unit 225 may be caused to process the URL. Accordingly, classifier 210 may produce a result using the fastest unit possible.

In other embodiments, processing a request may be according to another order. For example, cache unit 215, URL splitting unit 220, prefix lookup unit 225 and a deep semantic classification unit 230 may be made to process a request concurrently, simultaneously or in parallel. A time constraint may be set (e.g., by arming a timer), and upon an expiration of time the units may all be checked to determine whether they produced a result, e.g., a classification parameter or categorization of a webpage (or URL) associated with the request. As described herein, faster units may produce less accurate results, categorizations, classification parameters or classifications, accordingly, by allowing all units to operate in parallel, the likelihood of producing at least one result may be high and further, the most accurate result possible under the time constraint may be produced. For example, if cache 215 produces a result in less than 1 millisecond and URL splitting unit 220 requires 3 milliseconds to produce a result, then, if it is determined that providing a classification of a URL within 5 milliseconds is acceptable, it may be desirable to allow both cache 215 and URL splitting unit 220 to process a request for 5 milliseconds and then check both for a result. Next, if URL splitting unit 220 produced a result then such result may be selected as it may be more accurate than a result produced by cache 215. If URL splitting unit 220 failed to produce a result then a result produced by cache 215 may be selected.

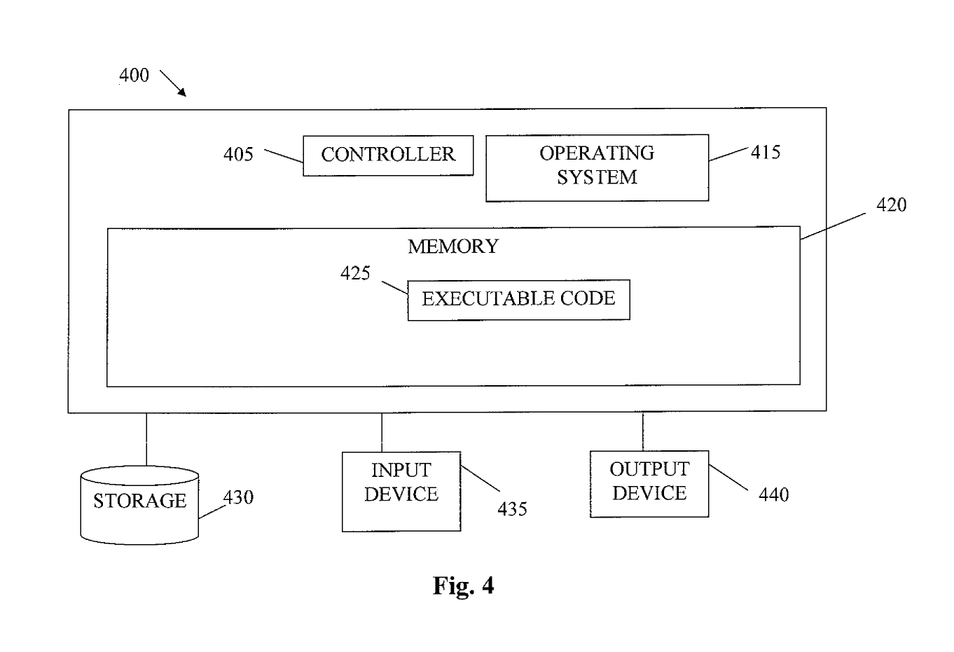

It will be understood that classifier 210 and associated units (e.g., cache unit 215, URL splitting unit 220, prefix lookup unit 225, deep semantic classification unit 230, third party information 235, manual entries 240 and statistical data unit 245) as shown in FIG. 2 and described herein is one exemplary embodiment selected from a number of possible embodiments. In one embodiment, classifier 210 and at least some of the connected and/or included components may be implemented as an appliance that may be placed in a suitable location, e.g., in a datacenter and/or close to (or even embedded in) an exchange described herein. In other embodiments, modules or units may be combined, e.g., URL splitting 220 and prefix lookup 225 may be combined into a single module. Likewise, modules and units shown may be divided into sub-modules or units. According to embodiments of the invention, classifier 210 and/or associated units cache unit 215, URL splitting unit 220, prefix lookup unit 225, deep semantic classification unit 230, third party information 235, manual entries 240 and statistical data unit 245 may be, may include and/or may be implemented using hardware, software, firmware and/or any combination thereof. For example, cache 215 may be a dedicated hardware module installed in a computing device, URL splitting unit 220 may be a chip and dedicated firmware operatively connected to a computing device (e.g., using an add-on card) and prefix lookup unit 225 may be a software module. In another embodiments some of the units in classifier 210 may be software modules installed on a computing device, e.g., as described herein with reference to FIG. 4.

Generally, classifier 210 may receive a request for an advertisement (that may be generated in order to populate a spot in a webpage as described herein) and may return a classification parameter for a URL (and/or a webpage) associated with the received request. For example, a request for an advertisement may be received in association with a URL, where the URL may be related to the webpage for which the advertisement is requested. Classifier 210 may analyze the URL and return a categorization or classification parameter related to the URL and/or associated webpage. A classification or categorization parameter (and possibly accompanied by an associated URL and various parameters related to the spot to be filled with an advertisement) may be provided to any applicable client or destination. For example, an advertiser (e.g., advertiser 140) whishing to bid for displaying advertisements may be provided with categorizing or classifying parameters that may be used by such potential bidder in order to decide whether to bid for placing his advertisement in a given webpage.

For example, an advertiser that may be interested in selling camping equipment may wish to bid for advertising in webpages related to scenic trips, nature resorts and the like but would rather not bid (and pay for) advertising in webpages related to arcade games. Accordingly, provided with a classification of a webpage by an embodiment of the invention, such advertiser may avoid paying for displaying his advertisements in webpages where his advertisements are unlikely to be effective (e.g., displayed to irrelevant user) and only bid for displaying advertisements in relevant webpages.

Another client or destination of output from embodiments of the invention such as classifier 210 may be an operator of an exchange. For example, based on a classification of a webpage, a publisher or an exchange operator (or application) may determine a minimum or entry price for bidding for a specific advertisement. For example, an exchange operator (or an automated procedure in an exchange) or a publisher may define an entry or minimum bidding price or cost in an auction for advertising in webpages related to shopping for gifts during a specific time period (e.g., during Christmas). Accordingly, based on a classification parameter provided by classifier 210, a publisher may determine the entry price for advertising in specific webpages based on their classification.

Since embodiments of the invention may provide a classification parameter related to advertising in a webpage in real-time, decisions made by clients (such as advertisers, an exchange or an entity monitoring online trends) may likewise be made in real-time. For example, an advertiser may place a bid and/or determine a price to be offered for advertising in a webpage at a time the webpage is already being served or provided to a user surfing the internet. Similarly, an exchange provided with output of classifier 210 may determine a price for displaying an advertisement in a webpage at a time the webpage is already rendered on a display of a user's home computer, laptop or wireless communication device.

Third party information 235 may be or may comprise a storage system or device where classification information related to domains, subdomains or page level information may be stored. For example, classification or categorization information from commercial or non-commercial bodies such as Alexa, DMOZ, or the Internet Architecture Board (IAB) standard may be collected and sites, URLs or even specific, discrete webpages may be associated with a classification parameter based on such information or sources. Information in the third party information module may be used to populate entries in prefix lookup 225. For example, simply described, prefix lookup 225 may include a list of entries in which each entry includes at least a classified object (e.g., a site, a URL, a part (e.g., a prefix) of a URL, one or more URL's prefixes, a domain or a subdomain etc.) and a classification parameter associated with the classified object. For example, an object may be “cnn.com” (that may be a prefix of a number of URLs) and an associated classification or categorization may “American news”, likewise, the object “sportsillustrated.cnn.com” may be classified as “Sports”, sportsillustrated.cnn.com/football may be classified as “Sports/Football” and “*.facebook.com” may be classified as “Internet/SocialNetworks”. A “*” in an object may denote any character, string or symbol. Any categories, e.g., as defined by a user or requested by interested parties such as publishers or advertisers may be defined and any object may be associated with any one or more classes, categories or other classifying parameters. As exemplified by the “*” above, any rules may be employed for classifying objects, thus automatic, generic or other classification methods may be employed in order to enable a system or method to classify any object. For example, a default classification may exist, or a classification based on a geographical location, time of day etc. may all be employed by embodiments of the invention.

According to embodiments of the invention, a URL or a prefix of a URL may be associated with a number of classifying parameters as described herein. Classifying a URL or a prefix as described herein may include associating the URL (or prefix) with a number of classification parameters which may be based on or according to various aspects. For example, a URL, URL prefix, a web site or webpage may be associated with a number of classifying parameters that may be related to a number of aspects. For example, a prefix in prefix lookup 225 may be classified according to a gender, a geographic parameter, an income related parameter, a weather parameter or any other parameter that may be applicable, e.g., to an advertising in a related webpage. For example, it may be determined that a specific webpage is typically requested or downloaded by web surfers of a specific socio-economical group. For example, the probability that a webpage is requested or downloaded by surfers associated with a range of predefined occupations, or surfers having a predefined range of income, number of children, or living in specific neighborhoods may be known. Likewise, a gender may be associated with webpages, web sites etc. For example, it may be determined or known that the majority of downloads from a known web site are performed by females and/or by females of a known age range (e.g., teenaged girls).

Information relating or associating webpages, web sites etc. with aspects such as gender, geographic location, income etc. may be obtained from any source as known in the art, e.g., surveys, statistics, content analysis of webpages, information provided (possibly anonymously) by users etc. Such sources may be external to classifier 210. For example, manual entries as described herein may include entries reflecting gender, income, geographic parameters etc. Other parameters may be automatically obtained. For example, as known in the art, internet protocol (IP) addresses may be allocated based on geographical parameters (e.g., a part of an IP address may indicate a country). Accordingly, geographical aspects related to requests may be obtained from protocol headers and an association of a web site or webpage with a specific geographical area may be made. Complex associations may be made in a classification of web sites or pages. For example, by observing weather reports and correlating them with requests received by web sites, an association of weather conditions with a web site or page may be made. For example, it may be determined that a specific webpage's popularity is related to weather (e.g., a site where coats are sold may gain popularity during a rainy season). It will be understood that the above correlation or association of web sites or pages with various aspects are exemplary ones and that any aspect may likewise be associated with a webpage, a URL or a URL prefix. In some embodiments, privacy issues may be observed. For example, information associating web pages or URLs with aspects as described herein may be statistical and anonymous such that a privacy of users or surfers is not jeopardized.

Accordingly, classifier 210 may classify a URL, webpage, web site or a URL prefix with one or more classification parameters that may be related to one or more aspects. For example, prefix lookup 225 may include multi level classification of URL prefixes. A plurality of classification parameters may be provided as described herein. For example, prefix lookup 225 may include a number of classifications for a given URL prefix and all or some of such classification parameters may be provided as described herein. Accordingly, an advertiser may base his or her bidding for displaying an advertisement in a webpage based on a number of classification parameters. For example, at the same time, a first advertiser, targeting potential male buyers, may base a bidding decision on a first classification parameter associated with a request as described herein, and a second advertiser, targeting potential young buyers, may base a bidding decision on a second parameter associated with the same request.

An automated procedure may be implemented to translate or transform information from external sources described herein such as those in third party unit 235, manual entries 240 and/or statistical data 245 to a format and/or taxonomy of prefix lookup 225. For example, classification information in external sources may be converted, modified or otherwise manipulated or processed and inserted into prefix lookup unit 225. Accordingly, prefix lookup unit 225 may include classification information based on any applicable external or internal source.

Manual entries unit 240 may store manual entries. For example, an employee may manually enter records comprising a classified object (e.g., one or more URL's prefixes, a site, a URL, a part of a URL, a domain or a subdomain) and a classification parameter associated with the classified object based on specific instructions. For example, a set of URLs or sites may be associated with a respective set of classification parameters and the employee may manually create records in manual entries 240 according to such sets. Additionally or alternatively, a user may identify unclassified objects, e.g., sites, domains or subdomains for which no classification exists in the system (e.g., in prefix lookup 225) but, in addition, requests for advertisements for these sites or domains as described herein are seen or recorded. Such unclassified yet relevant sites, URLs, domains or subdomains may be manually added to manual entries 240. Such manual process may lead, with a feasible effort, to an ever increasing, high-accuracy coverage of URLs.

Third party information module 235 and manual entries unit 240 may be used to construct an initial table or repository and further used to increase coverage of classified objects, but may not be suitable for maintaining a large database. For example, the number of relevant web sites and/or pages may be too large for a method of manually entering web sites or pages into a list or repository. In addition, sites (or content therein) typically change over time thus an entry made today may be irrelevant tomorrow, furthermore, new web sites and/or pages are added on a daily or even hourly basis. Such and other aspects may be dealt with by statistical data unit, module or repository 245.

Statistical data unit 245 may be used to evaluate, refine, update or otherwise process information in, or used by, classifier 210. For example, statistical data 245 may be used to refine or otherwise modify data in, or add data to, prefix lookup 225. In some embodiments, statistical information related to webpages, web sites etc. may be collected and examined. In addition other methods such as “machine learning” can be used for proper prefix classification. For example, prefix lookup 225 may contain the prefix “nbc.com” that may be classified as “American news”. Accordingly, requests associated with a URL containing this prefix, e.g., “http://www.nbc.com/travel/restaurants/index.htm”, “http://www.nbc.com/travel/bike/index.htm”, and “http://www.nbc.com/travel/hiking/index.htm” may all be classified as “American news”. Statistical or other algorithmic examination may discover that a large number of requests associated with the prefix “nbc.com” also contain travel. Otherwise put, statistical analysis may determine that the prefix “nbc.com/travel” appears a substantial number of times and/or that when “nbc.com” is seen the probability that “nbc.com/travel” will be observed is at least a predefined value or probability. Accordingly, it may be determined that the prefix “nbc.com/travel” merits its own classification. In such case semantic analysis of the prefix “nbc.com/travel” may be performed and this prefix may be associated with a classification, e.g., a “travel”, “trips”, “sightseeing” or other classification that may be more suitable.

Accordingly, a request for an advertisement for a webpage associated with the URL “http://www.nbc.com/news.htm” may be associated with the “American news” class but a request for an advertisement for a webpage associated with the URL “http://www.nbc.com/travel/outdoor/list.htm” may be classified as “travel” thus an advertiser for bikes may avoid bidding for advertising in a webpage containing daily news but bid for a camping related webpage although the two pages may be served by the same web site. As further described herein, statistical data 245 may alternatively or additionally be modified by deep semantic classification unit 230. Statistical calculations or aspects may further cause removal of classifications from prefix lookup 225 and/or cache 215. For example, it may be statistically determined that a specific prefix has not been observed for a predefined period of time or a predefined number of requests and accordingly, such prefix and associated classification may be removed from cache 215 and/or prefix lookup 225. It will be understood that any statistical analysis, algorithms, observations and/or units may be used in order to modify lookup tables or caches such as cache 215 and prefix lookup 225.

Although not shown, classifier 210 may include, be operatively connected to, or otherwise associated with any pre-processing component or unit that may process, and possibly modify a URL prior to the URL being provided to, and processed by classifier 210. For example, a component that may strip any redundant, irrelevant or other information from a URL may process a URL associated with a request for an advertisement and provide a processed URL to classifier 210. Like, such processing may be performed between units in classifier 210. For example, a URL provided to deep semantic classification unit 230 may be processed as described herein after being classified by unit 230 but before being provided to cache 215. Processing a URL as described herein may comprise transforming a URL to a canonical form which may be according to a form best suited for processing by cache 215. Accordingly, a preprocessor may receive a URL, transform it to a canonical form and provide the transformed URL to classifier 210.

As described herein, preprocessing a URL may comprise removing redundant information. For example, a URL received by classifier 210 may be in the form of “http://www.nbc.com/news?article=121 &sessionid=343248” in which “article” points to a specific article (121), which may be relevant to the classification. However, “sessionid”, may be a protocol parameter which may be unrelated to the actual webpage, website or domain, or otherwise irrelevant to a classification of the URL. Accordingly, a preprocessor may transform the above exemplary URL to http://www.nbc.com/news?article=121 and provide such transformed or preprocessed URL to classifier 210. Any preprocessing, transformation or manipulation may be performed on a URL either before it is being provided to classifier 210 or between a processing by a first and second units within classifier 210.

As described herein, cache 215 may be any caching system, device or unit and may include hardware, software, firmware or any combination thereof. Cache unit 215 may generally store a set of requests and respective classification. Cache 215 may be capable of providing a classification for a request (based on a previously determined classification) very fast. However, cache 215 may be limited to a number of entries that may not suffice for all requests that may be received by classifier 210. In some embodiments, if cache 215 fails to provide a classification for a request, the requests may be provided to URL splitting unit 220.

URL splitting unit 220 may split or parse a URL into two or more parts or terms, may semantically analyze such two or more parts of a URL and may associate a classification with the URL based on the semantic analysis. For example, a prefix of a URL of the form http://www.israelweather.co.il may be determined to be “israelweather”, such prefix may be split into “israel weather” and the terms “israel” and “weather” may be semantically analyzed. An analysis result may be used to associate a classification with the prefix, for example, a result of semantic analysis of the above URL may be used to associate the prefix “israelweather” with a category or class that may be “weather”, “weather in israel”, etc.

Various algorithms or techniques may be employed by URL splitting unit 220 when splitting and analyzing parts of a URL. For example, a prefix of a URL of the form “http://www.watchsmallvilleonline” may be split into “watchs mall vi (1) leon line” or into “watch smallville online” Accordingly, an algorithm that may best split a URL's prefix may be used. In some embodiments, after splitting a URL and semantically analyzing the parts resulting from such splitting, the analysis results and/or a classification made based on the results may be compared or otherwise related to known results or classifications in order to asses their relevance.

In a case where it may be determined that an analysis result or a resulting classification is unlikely to be relevant (e.g., similar classifications do not exist) the URL prefix may be split differently and the analysis and classification process may be repeated. Generally, splitting a URL and analysis of the resulting parts may comprise splitting the URL and determining if the resulting parts, terms or strings are known terms. In one embodiment, various characters may be identified as separating symbols. For example, in a URL containing the string “how-far-is-the-moon.html” the “-” character may be identified as a separator and, accordingly, splitting such URL may result in the terms “how”, “far”, “is”, “the”, “moon”. As exemplified, some terms or strings may be ignored. For example, the term “html” may be a known term and may be ignored in the process of splitting and/or analyzing a URL as described herein.

In some embodiments, splitting a URL may comprise only splitting the domain and sub-domain names in the URL. Probabilistic methods to decide the most plausible split may be employed. For example, existence of terms resulting from splitting a URL in a predefined dictionary may determine the most relevant split. For example, a URL containing the term “usnavy.com” may be split into “us”, “navy” and/or “usn”, “avy”. Based determining that both the terms “us”, and “navy” are found in a dictionary but none of the terms “usn” and “avy” are found in such dictionary, the first set may be chosen for analysis. Another example may be “supermanager.com” that may be split into “super” and “manager” or “superman” and “ger”. In this case, the first set may have to terms found in a dictionary while the second set may only have one such term, accordingly, the split yielding more known terms (e.g., the first in the above example) may be chosen for analysis. Various other rules, criteria or constraints may govern splitting of URLs. For example, a split that yields longer terms may be chosen, e.g., a split yielding “dandelion” may be preferred over one that yields “dan”, “de” and “lion”. Splitting a URL may be based on the analysis result of resulting terms. For example, after splitting a URL and semantically analyzing the resulting terms, a score (e.g., a confidence level) may be computed for, and associated with the result. Next, a different splitting may be attempted and the semantic analysis may be repeated. Next, the confidence levels or other scores associated with the analyses may be compared and the split associated with the highest score may be chosen.

In some embodiments, a classification of a URL performed by splitting as described above may be performed and the classification (or a parameter related to the classification) may be provided to a client as described herein. In other embodiments, a classification of a URL prefix produced by URL splitting unit 220 and an associated prefix may be provided to prefix lookup unit 225. Other sources providing input to prefix lookup unit 225 may be a third party information unit 235, manual entry module or repository 240 and a statistical data unit 245 as described herein.

URL prefix lookup unit 225 may contain or access a set of URL prefixes and associated classifications. As known in the art, a URL typically contains a domain or domain name, a sub domain or path and a file or page name or reference. A subdomain may be the domain and any part of a path, excluding the file or resource name. For example, in the URL “http://www.suntimes.com/entertainment/music/classical/1975430.html” the domain may be “www.suntimes.com” and “www.suntimes.com/entertainment/”, “www.suntimes.com/entertainment/music/” and “www.suntimes.com/entertainment/music/classical/” may be possible subdomains.

Typically, websites are arranged in a hierarchy, and in many cases, such hierarchy is reflected in the websites' URLs. For example, in the exemplary “http://www.suntimes.com/entertainment/music/classical/1975430.html” URL, it may be determined that the webpage or resource referenced by “1975430.html” is related to classical music. Accordingly, URL prefix lookup unit 225 may store (e.g., in a table, list or other construct) a list of URL prefixes and an associated class, category or related parameter. Thus, an accurate classification of URLs may be performed, including different classifications of different URLs provided by the same website. For example, a first URL prefix of the form “www.suntimes.com/entertainment/music/” may be classified or categorized as “music” and another, second URL prefix associated with the same website having the form of “www.suntimes.com/entertainment/books/” may be classified or categorized as “literature”. As described herein, possibly if no classification for a URL may be determined by URL splitting unit 220 then prefix lookup unit may examine any prefix of the URL, locate the prefix in a lookup table and return a classification of the URL as recorded in the lookup table. Any URL prefix may be stored in a lookup table in association with a categorizing or classification or a classification parameter.

For example, both the prefixes “www.suntimes.com/entertainment/” and “www.suntimes.com/entertainment/music/” may be stored and each may be associated with a different classification. Accordingly, an accuracy or granularity of a classification may be enhanced as a website expands as additional classifications for sections of a website may be automatically added to classifier 210 as described herein. As described herein, prefix lookup unit 225 or information therein may be updated or modified by any one of third party information repository or unit 235, manual entry module or repository 240 and a statistical data unit 245. For example, analysis of information in third party information unit 235 may produce an association of a set of URLs or prefixes of URLs with respective categories. such prefixes and associated categories may be provide to, and stored by, URL prefix lookup unit 225 and may further be used as described herein.

Deep semantic classification unit 230 may be activated in a number of modes or circumstances. For example, if other, possibly faster units in classifier 210 fail to produce a classification of a URL then deep semantic classification unit 230 may be made to examine or process the URL, in realtime and as described herein, determine a classification of the URL and provide a client with such classification or a classification parameter. In another embodiment, deep semantic classification unit 230 may semantically analyze URLs in the background, produce analysis results that may be used to associate a URL with a classification and provide such classification (and associated URL) to other units or components of classifier 210. For example, a classification of a URL or a prefix as determined by deep semantic classification unit 230 may be provided to prefix lookup unit 225 (and/or cache 215 as shown by the arrow connecting blocks 230 and 215), and used as described herein. Deep semantic analysis performed by unit 230 may be any analysis of any information related to a resource. For example, deep semantic analysis performed by deep semantic classification unit 230 may include using a provided URL to obtain the related webpage and semantically analyzing the webpage's content and or any content or information related to the webpage. Semantic analysis of content in a webpage may be performed using any algorithms, methods or means, e.g., as known in the art.

For example, text analysis may be performed on text in a webpage and image analysis may be performed on images in a webpage etc. Metadata related to a webpage may also be analyzed or taken into account. For example, the language used, the font used etc. may all be analyzed and used for categorizing a webpage by deep semantic classification unit 230. Although processing a webpage by deep semantic classification unit 230 as described herein may be relatively slow, a very accurate classification of webpages may be made possible by deep semantic classification unit 230, e.g., based on semantic or other analysis of content in the webpage. Accordingly, deep semantic classification unit 230 may be made to operate as a background process and may continuously update information in classifier 210, e.g., in prefix lookup unit 225.

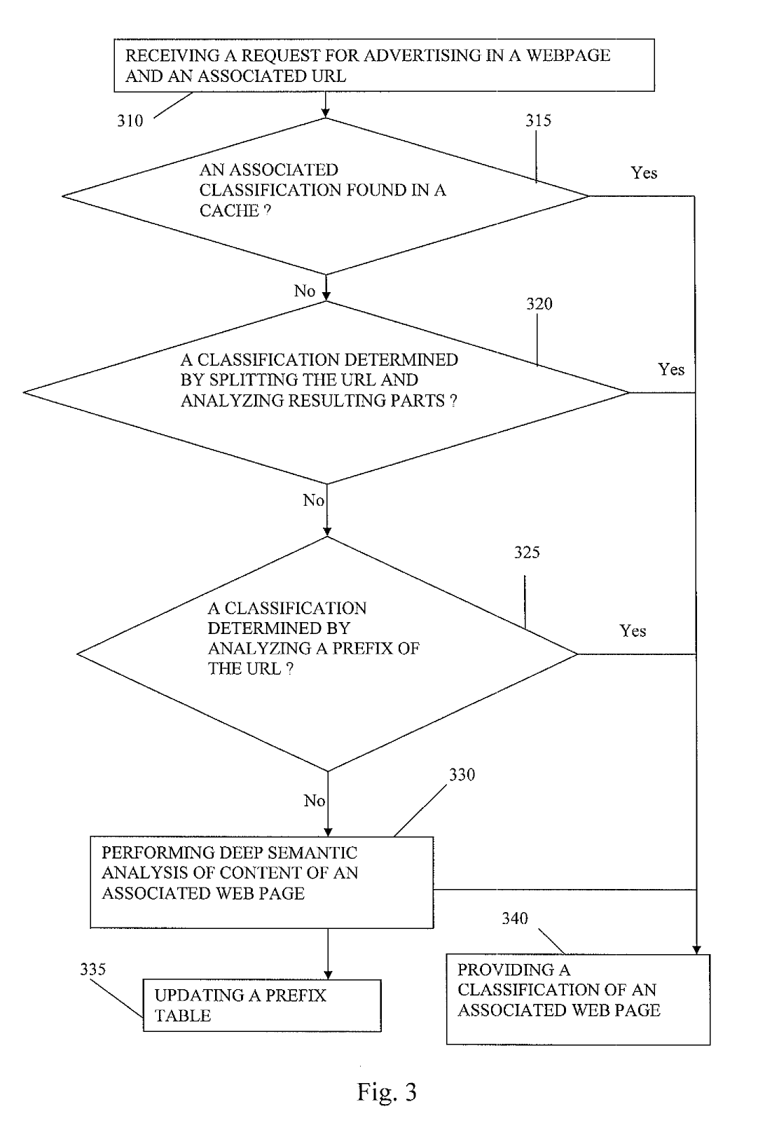

Reference is now made to FIG. 3 that depicts a method in accordance with an embodiment of the invention. As shown by block 310, the method or flow may include receiving a request for advertising in a webpage and an associated URL. For example, classifier 210 may receive a request for an advertisement to be placed in a webpage. As discussed herein, a URL associated with the request (e.g., with the associated webpage) may also be received by a classifier.

As shown by block 315, the method or flow may include determining of an associated classification is found in a cache. For example, a fast caching system (e.g., cache 215) may be provided with a request and may return a cached classification of the request, e.g., based on a previous response to the same or similar request. According to embodiments of the invention, at any stage more than one classification, categorization or other parameter may be returned for a single request. For example, a specific webpage may be relevant to both camping gear and global positioning systems (GPS). Accordingly, such webpage may be associated with a plurality of classes, e.g., the webpage may be classified as “camping”, “GPS” and “sport” and any or all of these classes may be returned for a request for an advertisement for the page. As further shown by the arrow connecting blocks 315 and 340, if a classification of the webpage or URL is determined or found by a cache it may be provided to a client (that may be an advertiser, a publisher, an exchange operator or other entity).

As shown by block 320, the method or flow may include determining if a classification of the webpage (or associated URL) was produced by splitting the URL and analyzing resulting parts. For example, if cache 215 does not produce a result (or hit as known in the art) the request (and associated URL) may be provided to URL splitting unit 220 as described herein and URL splitting unit 220 may provide a result in the form of one or more relevant or associated classes. As shown, if a classification is produced by analyzing parts of a URL split as described herein the classification may be provided to a client. Otherwise, the flow may continue as shown by the arrow connecting blocks 320 and 325.

As shown by block 325, the method or flow may include determining if a classification of the webpage (or associated URL) was produced by analyzing a prefix of the URL. For example and as described herein, prefix lookup unit 225 may determine if a prefix of the URL is found in a lookup table and if so, one or more classes associated with the request (or associated URL) may be provided as shown by block 340.

As shown by block 330, the method or flow may include performing deep semantic analysis of content of an associated web page. for example, if none of the units of classifier 210 produces a classification for a webpage or URL then a deep semantic (and/or other) analysis of the related webpage may be performed as described herein. As further shown by block 335, the method or flow may include updating a prefix table. For example, deep analysis classification performed by unit 230 of classifier 210 may determine one or more classifications of a webpage. Accordingly, an entry in prefix lookup unit 225 may be created to reflect such classification. Accordingly, a system according to embodiments of the invention may continually update its tables or other structures and may automatically adapt to changes made to websites. As shown by block 340, the method or flow may include providing a classification of an associated web page. For example, a class associated with a webpage (for which an advertisement is requested) may be provided to an advertiser that may determine whether or not to bid for advertising in the webpage based on the provided webpage's classification.

Reference is made to FIG. 4, showing high level block diagram of an exemplary computing device according to embodiments of the present invention. Computing device 400 may include a controller 405 that may be, for example, a central processing unit processor (CPU), a chip or any suitable computing or computational device, an operating system 415, a memory 420, a storage 430, an input device 435 and an output device 440.

Operating system 415 may be or may include any code segment designed and/or configured to perform tasks involving coordination, scheduling, arbitration, supervising, controlling or otherwise managing operation of computing device 400, for example, scheduling execution of programs. Operating system 415 may be a commercial operating system. Memory 420 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 may be or may include a plurality of, possibly different memory units.

Executable code 425 may be any executable code, e.g., an application, a program, a process, task or script. Executable code 425 may be executed by controller 405 possibly under control of operating system 415. Storage 430 may be or may include, for example, a hard disk drive, a floppy disk drive, a Compact Disk (CD) drive, a CD-Recordable (CD-R) drive, a universal serial bus (USB) device or other suitable removable and/or fixed storage unit. Although for the sake of simplicity, a single executable code 425 is shown it will be understood that any number of executable code segments may be loaded into memory 420. For example, a number of executable code segments implementing cache 215, URL splitting unit 220, prefix lookup 225 and/or deep semantic analysis module 230 may be loaded into memory 420.

Input devices 435 may be or may include a mouse, a keyboard, a touch screen or pad or any suitable input device. It will be recognized that any suitable number of input devices may be operatively connected to computing device 400 as shown by block 435. Output devices 440 may include one or more displays, speakers and/or any other suitable output devices. It will be recognized that any suitable number of output devices may be operatively connected to computing device 400 as shown by block 440. Any applicable input/output (I/O) devices may be connected to computing device 400 as shown by blocks 435 and 440. For example, a network interface card (NIC), a printer or facsimile machine, a universal serial bus (USB) device or external hard drive may be included in input devices 435 and/or output devices 440. According to embodiments of the invention, classifier 210 shown in FIG. 2 may comprise all or some of the components comprised in computing device 400 as shown and described herein.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein. For example, a storage medium such as memory 420, computer-executable instructions such as executable code 425 and a controller such as controller 405. Some embodiments may be provided in a computer program product that may include a non-transitory machine-readable medium, stored thereon instructions, which may be used to program a computer, or other programmable devices, to perform methods as disclosed above.

While certain features of embodiments of the invention have been illustrated and described herein, many modifications, substitutions, changes, and equivalents may occur to those skilled in the art. It is, therefore, to be understood that the appended claims are intended to cover all such modifications and changes as fall within the true spirit of embodiments of the invention.

What is claimed is:

1. A computer-implemented method comprising:
receiving a uniform resource locator (URL);
semantically analyzing text in said URL to produce analysis result;
associating said URL with an advertisement-related classification parameter based on said analysis result; and
using said classification parameter in a real time bidding (RTB) process for advertising in a webpage associated with said URL.

2. The computer-implemented method of claim 1, wherein said semantic analysis and said associating said URL with a classification parameter are performed in realtime, upon receiving a request for an advertisement to be presented in said webpage.

3. The computer-implemented method of claim 1, comprising splitting text in said URL to produce at least two terms and semantically analyzing said at least two terms.

4. The computer-implemented method of claim 1, comprising identifying a domain name in said URL and performing semantic analysis of said domain name.

5. The computer-implemented method of claim 1, comprising identifying at least one subdomain name in said URL and semantically analyzing said at least one subdomain name.

6. The computer-implemented method of claim 1, comprising identifying a prefix portion in said URL and semantically analyzing said prefix portion.

7. The computer-implemented method of claim 1, comprising updating a prefix lookup table according to said URL and said associated classification parameter.

8. The computer-implemented method of claim 7, comprising associating said URL with said classification parameter based on said prefix lookup table.

9. The computer-implemented method of claim 1, comprising:
associating said URL with at least two advertisement-related classification parameters; and
using said at least two classification parameter in a real time bidding (RTB) process for advertising in a webpage associated with said URL.

10. The computer-implemented method of claim 7, comprising updating said prefix lookup table according to at least two classification parameters associated with said URL and providing said at least two classification parameters in response to a request for an advertisement to be presented in a webpage associated with said URL.

11. The computer-implemented method of claim 7, comprising:
statistically analyzing a reception of a plurality of requests for advertisements associated with a respective plurality of URLs; and
selecting to update said lookup table according to at least one of said URLs based on said statistical analysis.

12. The computer-implemented method of claim 7, further comprising:
semantically analyzing content in a webpage associated with said URL to produce an analysis result;
associating said URL with said classification parameter based on said analysis result; and
updating said lookup table according to said URL and said associated classification parameter.

13. An article comprising a computer-readable storage medium, having stored thereon instructions, that when executed on a computer, cause the computer to:
receive a uniform resource locator (URL);
semantically analyze text in said URL to produce analysis result;
associate said URL with an advertisement-related classification parameter based on said analysis result; and
use said classification parameter in a real time bidding (RTB) process for advertising in a webpage associated with said URL.

14. The article of claim 13, wherein said semantic analysis and said associating said URL with a classification parameter are performed in realtime, upon receiving a request for an advertisement to be presented in said webpage.

15. The article of claim 13, wherein the instructions when executed further result in splitting text in said URL to produce at least two terms and semantically analyzing said at least two terms.

16. The article of claim 13, wherein the instructions when executed further result in identifying a domain name and a subdomain name in said URL and performing semantic analysis of said domain name and said subdomain name.

17. The article of claim 13, wherein the instructions when executed further result in identifying a prefix portion in said URL and semantically analyzing said prefix portion.

18. The article of claim 13, wherein the instructions when executed further result in updating a prefix lookup table according to said URL and said associated classification parameter.

19. The article of claim 18, wherein the instructions when executed further result in associating said URL with said classification parameter based on said prefix lookup table.

20. The article of claim 13, wherein the instructions when executed further result in:
associating said URL with at least two advertisement-related classification parameters; and
using said at least two classification parameter in a real time bidding (RTB) process for advertising in a webpage associated with said URL.

21. The article of claim 18, wherein the instructions when executed further result in: updating said prefix lookup table according to at least two classification parameters associated with said URL and providing said at least two classification parameters in response to a request for an advertisement to be presented in a webpage associated with said URL.

22. The article of claim 18, wherein the instructions when executed further result in:
statistically analyzing a reception of a plurality of requests for advertisements associated with a respective plurality of URLs; and
selecting to update said lookup table according to at least one of said URLs based on said statistical analysis.

23. The article of claim 18, wherein the instructions when executed further result in:
semantically analyzing content in a webpage associated with said URL to produce an analysis result;
associating said URL with said classification parameter based on said analysis result; and
updating said lookup table according to said URL and said associated classification parameter.
